(19) United States
(12) Patent Application Publication
(10) Pub. No.: US 2007/0213460 A1
(43) Pub. Date: Sep. 13, 2007

(54) Antimicrobial Nano Silver Additive for Polymerizable Dental Materials

(75) Inventors: Klaus Ruppert, Maintal (DE); Andreas Grundler, Wuppertal (DE); Albert Erdrich, Bad Nauheim (DE)

Correspondence Address: NORRIS, MCLAUGHLIN & MARCUS, PA, 875 THIRD AVENUE, 18TH FLOOR, NEW YORK, NY, 10022, US

(73) Assignee: Heraeus Kulzer GmbH, Hanau (DE)

(21) Appl. No.: 10/583,441

(22) PCT Filed: Dec. 13, 2004
(86) PCT No.: PCT/EP04/14149

§ 371 Date: Apr. 12, 2007

(30) Foreign Application Priority Data
Dec. 17, 2003 (DE) 103 59 338.1

(51) Int. Cl. C08G 63/00

(52) U.S. Cl. 525/14

(57) ABSTRACT

Disclosed are polymerizable dental materials containing silver particles having a primary particles diameter <40 nm as an antimicrobidal additive. The inventive dental materials are suitable as filling composites, basic prosthetic materials, adhesives, coating composites for crowns and bridges, and materials for artificial teeth, for example.

### The invention relates to polymerizable dental materials containing elemental silver as an antimicrobial additive.

Polymerizable dental materials such as filling composites, for example, exhibit a certain volume shrinkage during the polymerization reaction which is not totally avoidable, even with the skillful selection of monomers and the addition of inorganic fillers. Despite the use of adhesives, which are intended to ensure optimum bonding of the filling material to the tooth substance, this shrinkage can lead to formation of peripheral gaps, resulting in infiltration of microorganisms and secondary dental caries.

In this case, silver amalgam traditionally used as a dental material has an advantage, in that the antimicrobial properties of the amalgam substituents permit little or no secondary dental caries in spite of the pronounced tendency of the amalgam to form peripheral gaps.

The general and patent literatures contain numerous references to germicidal additives such as antibiotics, for example, to remedy this shortcoming of filling composites. Another problem is the anticipated resistance of the oral microflora to widely used antibiotics. Furthermore, this creates a practical problem for the manufacturer prior to marketing, since the requirements for registering an antibiotic may change as a result of the administration, and a medicinal product may lead to a drug with much more involved registration procedures.

Silver is known as a germicidal additive. However, silver is generally used not in the elemental form, but rather in the form of glass compositions (U.S. Pat. No. 6,593,260 B2, Ishizuka Garasu Kabushiki Kaisha), core-shell particles (U.S. Pat. No. 5,180,585, DuPont de Nemours), co-dosages of core-shell particles (U.S. Pat. No. 5,180,585, DuPont de Nemours), co-dosages of silicic acid (EP 1 083 146 A1, Degussa), complexed silver compounds (U.S. Pat. No. 5,985,308, Westham Technologies) applied to zeolites, etc.

Porous silver particles having diameters in the lower micron range are also known (DE 101 46 050 A1, WO 03/024494 A1, DE 102 05 600 A1, WO 02/17984 A1).

The silver particles proposed therein are generally several microns in diameter, and are also usually aggregated/agglomerated. The material therefore always has a dark intrinsic color. Thus, most of the silver materials described in these documents are not considered for use in tooth-colored dental materials, since, even in low concentrations, product characteristics such as color and transparency may be adversely affected.

To avoid such disadvantages, a polymerizable dental material is proposed which contains nanoscale silver particles as an antimicrobial additive which
have a primary particle diameter of <40 nm, preferably 1-40 nm, particularly preferably 1-20 nm (thereby producing no optical refraction or diffraction effects).

The antimicrobial effect may be achieved with 1 ppm silver, in particular 10 ppm, and particularly preferably 100 ppm silver. The maximum proportion of silver may be as high as 10% by weight, and preferably is less than 5% by weight, particularly preferably less than 2% by weight.

The particles preferably exhibit at least one of the following additional features, namely, that they:
are homogeneously incorporated into the dental material and therefore do not constitute a surface coating. For this reason, the loss of activity which takes place naturally due to detrition of the coating in filling materials, for example, cannot occur. The bulk material represents a constant silver depot from which silver may outwardly diffuse or be consumed by dissolution processes, thus ensuring a long-term effect;
are not agglomerated, since agglomeration would result in adverse optical effects;
are not applied to carrier or auxiliary substances;
are provided for incorporation in conjunction with a surface modification; and
are introduced into the dental material in the form of an acrylate dispersion.

The proposed material has the following advantages:
1. The nanoscale particle diameters create a very high specific surface. In this manner the overall silver concentration in the filling composite may be held to a relatively low value while still ensuring the long-term antimicrobial effect.
2. The nanoparticles do not appear black or gray in light, as is usually the case with silver, and do not impair the color of the dental material. The transparency of the material is not reduced appreciably, since the particle size is smaller than the wavelength of visible light (< 1/20 of the spectral region of 420 to 750 nm).
3. One problem with the use of silver is that excessively high concentrations of silver ions may have a toxic effect (DE 102 05 600 A1). The formation of high concentrations of soluble silver compounds is therefore not desirable. These problems cannot occur with the proposed material.

A form of nanoscalar silver that is suitable for the materials according to the invention is marketed by Bio-Gate Bioinnovative Materials, Nuremberg. Recommended applications are coatings for textiles, fabrics, and bone implant materials, and adhesive and coating substances.

The silver preferably is contained in the dental material in a proportion of 0.05 to 0.5%.

The materials according to the invention are suitable in the field of dentistry as filling composites, prosthetic base materials, adhesives, veneer composites for crowns and bridges, and materials for artificial teeth, for example.

The following exemplary embodiment explains the invention without being limited thereto:

A sample was withdrawn from the “Venus/Heraeus Kulzer” dental filling composite material having the following components:
A Acrylate-based monomers
B Dental glass as inorganic filler, particle size approximately 1 μm
C Silicic acid as inorganic filler, primary particle size <40 μm
D Stabilizers, initiators
   and was cured using a Translux Energy lamp.

Ag nanoparticles (BioGate, Erlangen) having an average diameter of approximately 5 nm were homogeneously incorporated into the remaining compound in a concentration of approximately 50 ppm, using a kneader for a period of 30 minutes.

An additional sample was withdrawn and cured using a Translux Energy lamp.

There was no difference in color between the two cured samples.

Of course, the silver nanoparticles or the dispersion thereof may also be incorporated at a suitable point during the production process for the filling composite.

1. A polymerizable dental material comprising silver particles which have a primary particle diameter of <40 nm.

2. Dental material according to claim 1, which comprises a mass proportion of silver therein of 1 ppm minimum to 10% by weight maximum.

3. Dental material according to claim 2, wherein the silver particles have a primary particle diameter of 1-20 nm.

4. Dental material according to claim 1, wherein the silver particles are homogeneously incorporated into the dental material.

5. Dental material according to claim 1 wherein the silver particles are not agglomerated.

6. Dental material according to claim 1, wherein the silver particles are modified on a surface thereof.

7. Dental material according to claim 1, wherein the silver particles are introduced into the dental material in the form of an acrylate dispersion.

8. Dental material according to claim 1, wherein the silver particles are not applied to carrier or auxiliary substances.

9. A filling composite comprising a dental material according to claim 1.

10. An adhesive comprising a dental material according to claim 1.

11. A prosthetic base material comprising a dental material according to claim 1.

12. A material for artificial teeth comprising a dental material according to claim 1.

13. A veneer composite for crowns and bridges comprising a dental material according to claim 1.

14. A fissure sealant comprising a dental material according to claim 1.

15. A protective dental lacquer for a surface treatment of natural teeth comprising a dental material according to claim 1.
